(19) United States
(12) Patent Application Publication
(10) Pub. No.: US 2013/0055877 A1
(43) Pub. Date: Mar. 7, 2013

(54) CAPO DEVICE

(71) Applicant: Jim Duncan, Biggar (GB)

(72) Inventor: Jim Duncan, Biggar (GB)

(21) Appl. No.: 13/578,167

(22) PCT Filed: Jan. 31, 2011
(86) PCT No.: PCT/GB2011/050150

§ 371 Date: Oct. 26, 2012

(30) Foreign Application Priority Data
Feb. 9, 2010 (GB) 1002081.6

(51) Int. Cl. G10D 3/04

(52) U.S. Cl. 84/318

(57) ABSTRACT

A capo device comprising: a substantially planar plate member having a string contacting material provided at a first face of the plate member; a strap extending from one end of the plate member for winding around the neck of an instrument in a first winding direction; a retaining member provided at the plate member and adapted to slidably retain the strap such that a portion of the strap can be doubled back in a second and opposing winding direction; and means for releasably fixing the doubled back portion of the strap.

The present invention relates to capos for musical instruments.

Musicians, such as guitarists, often use a capo to raise the pitch of an instrument. Conventional capos are available in a small number of particular forms. Many musicians would like to carry the capo on their person, such as in a pocket, but conventional capos tend to be relatively large and bulky. For instance, products from a well known manufacturer, Shubb™, tend to be formed from steel and so are relatively bulky and heavy.

Probably the smallest and most planar conventional capo has a plate with a string contacting material on one face and a number of teeth extending from the opposite face. A strap for wrapping around the neck of the instrument has a first end attached to the plate and a second end attached between two ends of a lever tab. The lever tab includes prongs which are engagable with the teeth. Since the strap is attached to the lever tab between its two ends, pivoting the lever tab about the prongs when engaged with the appropriate teeth tensions the strap which causes the string contacting material of the plate to press down on the instrument's strings. The capo is also held in position on the instrument using this tension and the angled orientation of the teeth inhibits the lever tab from disengaging with the teeth when the lever tab has been pivoted until it is parallel with the plane of the plate.

This form of capo is known to have a number of disadvantages. Firstly, although the capo is fairly planar and relatively light, it cannot be collapsed or folded up for carrying. In particular, the length of the strap is selected for wrapping around the neck of the instrument and so, without the instrument, the strap is too loose for the prongs of the lever tab to be retained by tension in the teeth. Therefore, the strap and lever tab simply hang loose.

It is desirable to provide a relatively light and non-bulky capo which can be coiled, collapsed and/or folded when not in use.

Secondly, the teeth are provided at a number of discrete locations, which represent a number of discrete engagement positions. Depending on the dimensions of the neck of the instrument, the actual desired engagement position may be in between two adjacent engagement positions. This leads to the capo being either too loosely or two tightly applied to the instrument. A loose capo results in an inferior sound from the instrument while overtight capos commonly spring off the instrument.

Thirdly, the above described capo is one of the simplest and easiest to produce of the available capos and yet it still has a complexity. In particular, the series of teeth with their angled orientation and rounded profile must be formed.

It is desirable to provide a relatively simple and easy to produce capo. It is desirable to provide such as capo which provides a continuous, rather than discrete, means for attachment to the instrument.

According to a first aspect of the present invention there is provided a capo device comprising:
a substantially planar plate member having a string contacting material provided at a first face of the plate member;
a strap extending from one end of the plate member for winding around the neck of an instrument in a first winding direction;
a retaining member provided at the plate member and adapted to slidably retain the strap such that a portion of the strap can be doubled back in a second and opposing winding direction; and
means for releasably fixing the doubled back portion of the strap.

The capo device may be adapted to be fully windable when not in use. The capo device may be fully windable to form a capo device which is still substantially planar when wound.

The strap may be fully windable in the first winding direction when the capo device is not in use. Alternatively or in addition, the strap may be fully windable in the second winding direction when the capo device is not in use. Alternatively or in addition, the strap may be fully windable when the capo device is not in use by winding in the first winding direction and then doubling back and winding in the second winding direction.

The releasable fixing means may comprise Velcro™. At least a portion of the releasable fixing means may be provided at a surface of the strap which is exterior in use so as to receive the doubled back portion.

The retaining member may comprise an aperture, slot, hook or the like provided at the plate member.

The capo device may include a loop member to provide a key ring or the like. The plate member may include an aperture for receiving the loop member. In one embodiment, the loop member may provide the retaining member.

The plate member may include a recess for receiving the string contacting material. The string contacting material may be bonded to the plate member using an adhesive.

According to a second aspect of the present invention there is provided a capo device comprising:
a substantially planar plate member having a string contacting material provided at a first face of the plate member;
a resilient elongate member which is located or locatable at one end of the plate member for winding around the neck of an instrument; and
a retaining member provided at the plate member to retain the elongate member.

The elongate member may include a first end member. The first end member may normally extend in a direction normal to the longitudinal axis of the elongate member. The elongate member may be attached at a mid-point of the first end member.

The elongate member may include a second end member. The second end member may normally extend in a direction normal to the longitudinal axis of the elongate member. The elongate member may be attached at a mid-point of the second end member.

The first end member may be located or locatable at a first end of the plate member. The first end member may be locatable in a first channel provided at the first end of the plate member. The first channel may extend between two longitudinal edges of the plate member.

The plate member may include a first aperture extending between a first planar surface and a second planar surface of the plate member. The first aperture may be configured to allow the first end member to be threaded into the first aperture for retaining in the first channel. The first aperture may be provided within the first channel. The first aperture may be provided at a mid-point of the first channel.

The second end member may be located or locatable at a second end of the plate member. The second end member may be locatable in a second channel provided at the second end of the plate member. The second channel may extend between two longitudinal edges of the plate member.

The plate member may include a groove member provided at the second end of the plate member. The groove member may be configured to prevent or inhibit lateral movement member of the elongate member when the second end member is located in the second channel . The groove member may be provided adjacent the second channel. The groove member may be provided adjacent a mid-point of the second channel.

The capo device may be adapted such that the distance between the first and second channels substantially corresponds to the length of the elongate member when in a relaxed state between the first and second end members. Holding means may be provided at a second face of the plate member opposite the first face for releasably holding the elongate member when the first end member is located in the first channel and the second end member is located in the second channel and the elongate member extends along the second face. This provides storage means for storing the elongate member along with the plate member when not in use.

The capo device may include a loop member to provide a key ring or the like. The plate member may include an aperture for receiving the loop member. In one embodiment, the loop member may provide the retaining member.

The plate member may include a recess for receiving the string contacting material. The string contacting material may be bonded to the plate member using an adhesive.

Embodiments of the present invention will now be described, by way of example only, with reference to the accompanying drawings in which:

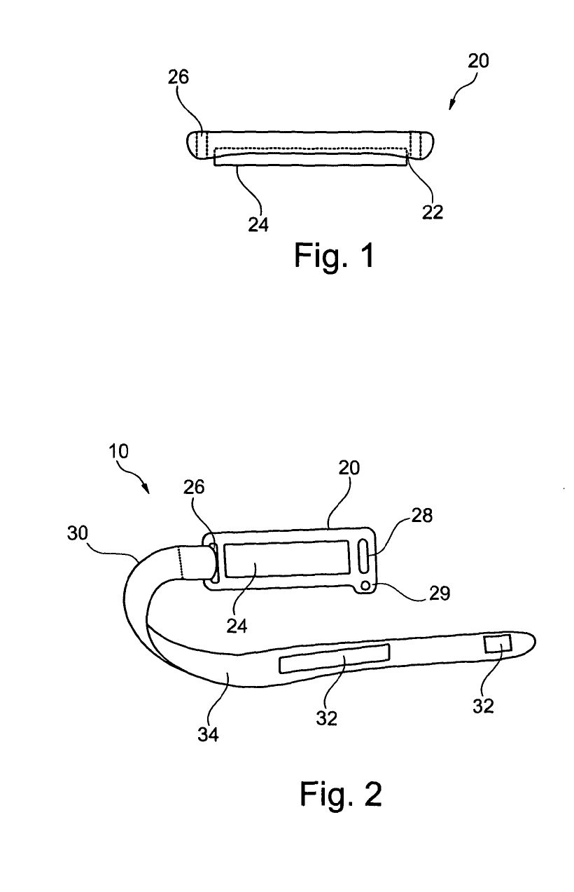

FIG. 1 is a side view of a plate of a first embodiment of a capo device;

FIG. 2 is a plan view of the capo device;

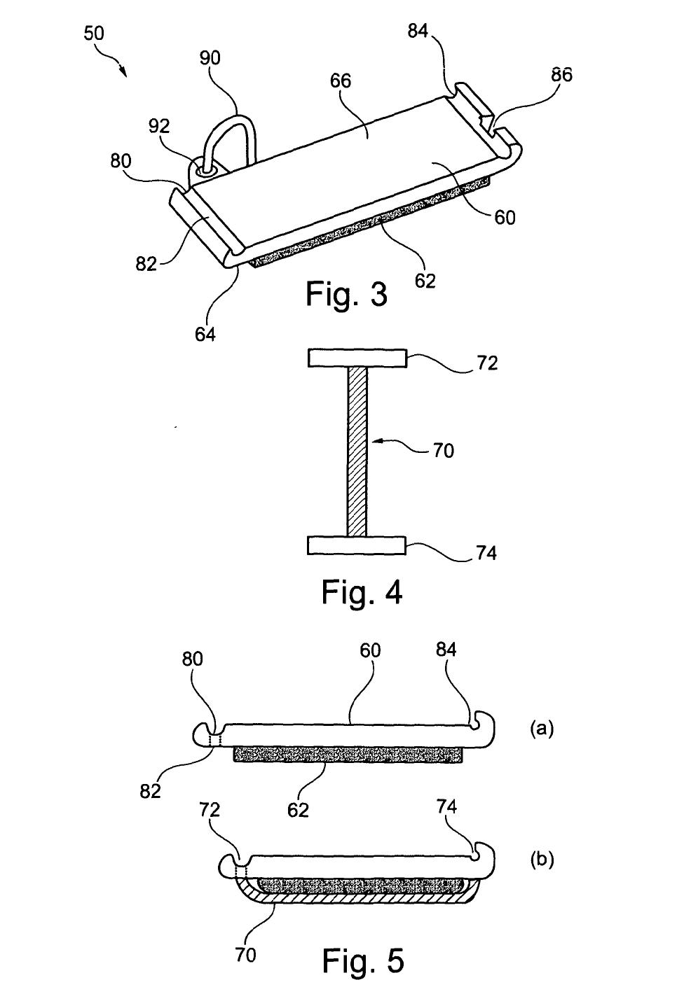

FIG. 3 is a perspective view of a plate of a second embodiment of a capo device;

FIG. 4 is a plan view of an elongate member of the capo device; and

FIG. 5 is a side view of (a) the plate of FIG. 3 and (b) the capo device.

FIG. 1 shows a plate 20 of a capo device 10 which is shown in FIG. 2. The plate 20 is substantially planar and includes a recess 22 at one planar face. Bonded to the plate 20 within the recess 22 is a planar string contacting material 24.

As shown best in FIG. 2, the plate 20 includes a first slot 26 provided at a first end of the plate 20. A strap 30 has a first end threaded into the first slot 26 and then sewn to itself so that it is fixed to the first end of the plate 20. The strap 30 extends from the first end for winding around the neck of an instrument in a first winding direction.

A retaining member in the form of a second slot 28 is provided at the second end of the plate 20. The second slot 28 is adapted to slidably retain the strap such that a portion of the strap can be doubled back in a second and opposing winding direction. In other words, the strap 30 which has been wound around the neck of the instrument can then be fed into the second slot 28 then doubled back. Indeed, pulling the doubled back strap 30 provides a taughtness of the strap 30 so that the string contacting material 24 is pressed firmly against the instrument strings.

Means for releasably fixing the doubled back portion of the strap is provided in the form of Velcro™ strips 32. These are provided at a surface 34 of the strap 30 which is exterior in use so that the two strips come in contact when the strap 30 is doubled back. The length of the strips 32 can be arranged to provide a wide range of circumscribed area (corresponding to the neck of the instrument) with infinite adjustment within this range. As the tension on the strap 30 is in the direction of the longitudinal axis of the strap 30, there is a minimal separating force which could cause separation of the strips 32.

In an alternative embodiment, the strap 30 can be formed from a one strap Velcro™. This comprises a planar material which has the hooks on one surface and the loops on the other opposing surface. Therefore, when the strap 30 is doubled back, the two surfaces can be brought together so that the strap 30 can be fastened to itself.

The capo device 10 can be adapted to be fully windable when not in use. In the absence of the instrument, the strap 30 is wound around the plate 20. When fully wound, two strips 32 are predetermined to be adjacent each other for holding the device 10 in this wound state.

The capo device also includes a loop (not shown) to provide a key ring. The plate 20 includes an aperture 29 for receiving the loop.

FIGS. 3 to 5 show a second embodiment of the present invention.

The capo device 50 again includes a planar plate 60 having a string contacting material 62 bonded to a first face 64 of the plate 60. However, in this embodiment, a resilient elongate member 70 is provided. This is locatable at one end of the plate 60 for winding around the neck of an instrument and a retaining member is provided at the second end of the plate 60 to retain the elongate member 70.

A first end of the elongate member 70 is attached to a mid-point of a first end member 72. The first end member 72 normally extends normal to the longitudinal axis of the elongate member 70. Similarly, a second end of the elongate member 70 is attached to a mid-point of a second end member 74. The second end member 74 also normally extends in a direction normal to the longitudinal axis of the elongate member 70.

The plate 60 includes a first channel 80 provided at its first end. This first channel 80 extends between the two longitudinal edges of the plate 60. A first aperture 82 extending between the first face 64 and a second face 66 of the plate 60 is provided at a mid-point of the first channel 80. This allows the first end member 72 to be threaded through the first aperture 82 by twisting the first end member 72 so that it is substantially coaxial with the elongate member 70. The first end member 72 can then be untwisted and then located in the first channel 80.

The string contacting material 62 can be applied to the instrument strings and the elongate member 70 wound around the instrument neck which also stretches the elongate member 70.

The second end member 74 can then be located in a second channel 84 provided at a second end of the plate 60 and which also extends between two longitudinal edges of the plate 60. The plate 60 includes a groove 86 provided at its second end which prevents lateral movement member of the elongate member 70.

In this embodiment, the elasticity of the elongate member 70 causes the string contacting material 62 to be firmly applied to the instrument strings.

The distance between the first and second channels can be configured to correspond to the length of the elongate member 70 when in a relaxed state.

Holding means (not shown) can be provided at the second face 66 to releasably hold the elongate member 70 when it is located in the first and second channels. This allows storing of the elongate member along with the plate 60 when not in use.

The capo device 60 again includes a loop 90 to provide a key ring. The plate 60 includes an aperture 92 for receiving the loop 90.

Whilst specific embodiments of the present invention have been described above, it will be appreciated that departures from the described embodiments may still fall within the scope of the present invention.

1. A capo device comprising:
a substantially planar plate member having a string contacting material provided at a first face of the plate member;
a strap extending from one end of the plate member for winding around the neck of an instrument in a first winding direction;
a retaining member provided at the plate member and adapted to slidably retain the strap such that a portion of the strap can be doubled back in a second and opposing winding direction; and
means for releasably fixing the doubled back portion of the strap.

2. The capo device as claimed in claim 1, wherein the capo device is adapted to be fully windable when not in use.

3. The capo device as claimed in claim 2, wherein the capo device is fully windable to form a capo device which is still substantially planar when wound.

4. The capo device as claimed in claim 2, wherein the strap is fully windable in the first winding direction when the capo device is not in use.

5. The capo device as claimed in claim 1, wherein at least a portion of the releasable fixing means is provided at a surface of the strap which is exterior in use so as to receive the doubled back portion.

6. The capo device as claimed in claim 1, wherein the retaining member comprises an aperture, slot or hook provided at the plate member.

7. The capo device as claimed in claim 1, wherein the capo device includes a loop member to provide a key ring.

8. The capo device as claimed in claim 1, wherein the plate member includes a recess for receiving the string contacting material, and wherein the string contacting material is bonded to the plate member using an adhesive.

9. A capo device comprising:
a substantially planar plate member having a string contacting material provided at a first face of the plate member;
a resilient elongate member which is located or locatable at one end of the plate member for winding around the neck of an instrument; and
a retaining member provided at the plate member to retain the elongate member.

10. The capo device as claimed in claim 9, wherein the elongate member includes a first end member which normally extends in a direction normal to the longitudinal axis of the elongate member.

11. The capo device as claimed in claim 10, wherein the elongate member includes a second end member which normally extends in a direction normal to the longitudinal axis of the elongate member.

12. The capo device as claimed in claim 10, wherein the first end member is located or locatable at a first end of the plate member.

13. The capo device as claimed in claim 12, wherein the first end member is locatable in a first channel provided at the first end of the plate member.

14. The capo device as claimed in claim 13, wherein the plate member includes a first aperture extending between a first planar surface and a second planar surface of the plate member, and wherein the first aperture is configured to allow the first end member to be threaded into the first aperture for retaining in the first channel.

15. The capo device as claimed in claim 14, wherein the first aperture is provided within the first channel.

16. The capo device as claimed in claim 11, wherein the second end member is located or locatable at a second end of the plate member.

17. The capo device as claimed in claim 16, wherein the second end member is locatable in a second channel provided at the second end of the plate member.

18. The capo device as claimed in claim 17, wherein the plate member includes a groove member provided at the second end of the plate member, the groove member being configured to prevent or inhibit lateral movement member of the elongate member when the second end member is located in the second channel.

19. The capo device as claimed in claim 18, wherein the groove member is provided at or adjacent the second channel.

20. The capo device as claimed in claim 17, wherein the capo device is adapted such that the distance between the first and second channels substantially corresponds to the length of the elongate member when in a relaxed state between the first and second end members.

21. The capo device as claimed in claim 20, wherein holding means is provided at a second face of the plate member opposite the first face for releasably holding the elongate member when the first end member is located in the first channel and the second end member is located in the second channel and the elongate member extends along the second face.

22. The capo device as claimed in claim 9, wherein the capo device includes a loop member to provide a key ring.

23. The capo device as claimed in claim 9, wherein the plate member includes a recess for receiving the string contacting material.

24. The capo device as claimed in claim 23, wherein the string contacting material is bonded to the plate member using an adhesive.
